(19) United States
(12) Patent Application Publication
(10) Pub. No.: US 2025/0355781 A1
(43) Pub. Date: Nov. 20, 2025

(54) TELEMETRY DATA COLLECTION IN CHIPLET PROCESSOR ARCHITECTURE

(71) Applicant: Openchip & Software Technologies S.L., Barcelona (ES)

(72) Inventors: Francesc Guim Bernat, Barcelona (ES); Violante Moschiano, Avezzano (IT); Edgar Gonzalez Pellicer, Girona (ES); Gaspar Mora Porta, Castellon de la Plana (ES); Tommaso Vali, Sezze (IT); Satoru Tagaya, Barcelona (ES); Erich Ludwig Focht, Stuttgart (DE)

(21) Appl. No.: 19/282,561

(22) Filed: Jul. 28, 2025

Related U.S. Application Data
(63) Continuation of application No. PCT/EP2025/053269, filed on Feb. 7, 2025.

(51) Int. Cl. G06F 11/34; G06F 9/54; G06F 11/30; G06F 18/2433

(52) U.S. Cl. CPC G06F 11/3466; G06F 9/542; G06F 11/3003; G06F 18/2433

(57) ABSTRACT

Aspects of telemetry data monitoring and event identification are described. An example method performed by telemetry monitoring circuitry includes: obtaining telemetry data samples associated with execution of a process on hardware resources, the hardware resources configured to perform compute operations in a computing platform; identifying an outlier condition applicable to the execution of the process, based on analysis of the telemetry data samples using at least one analytic model; and in response to identifying the outlier condition, generating at least one event for additional telemetry data analysis associated with the process based on applicable rules defined for the process, wherein the at least one event is provided to other instances of the telemetry monitoring circuitry in the computing platform.

### STATEMENT OF FUNDING

This application is a continuation of International Application No. PCT/EP2025/053269, filed Feb. 7, 2025, which is incorporated herein by reference in its entirety.

### STATEMENT OF FUNDING

This invention was made with government support under Grant UNICO-IPCEI-2023-001 funded by the European Union-Next Generation EU, Important Projects of Common European Interest (IPCEI).

### BACKGROUND

Telemetry generally refers to processes for monitoring, collecting, transmitting, and analyzing data from different sources of a computing system. The analysis of this data can be used to gain insights related to system performance and operational health and used to trigger various responses. The data that is collected from telemetry operations is often referred to as “telemetry data” or simply “telemetry”.

Some approaches for performing telemetry operations are based on the collection and retrieval of data logged in response to certain pre-programmed rules or conditions. For instance, telemetry data from a computing system might be captured and processed at a hardware level, such as by assigning specific hardware elements to monitor a limited number of telemetry counters, and receiving callbacks when an overflow occurs on specific telemetry counters. In other scenarios, telemetry data might be processed at a management software stack level, but with the expense of significant overhead and complexity to identify and handle events indicated in the telemetry data. Either scenario can become significantly complex as the scale of computing systems grows, since computing systems may be composed from hundreds or thousands of individual processing elements-and thus, potentially millions of potential monitoring counters and triggering events from telemetry.

### BRIEF DESCRIPTION OF THE DRAWINGS

In the drawings, which are not necessarily drawn to scale, reference numerals are repeated to describe similar components in different views. Like numerals having different letter suffixes may represent different instances of similar components. The drawings illustrate generally, by way of example, but not by way of limitation, various embodiments discussed in the present document.

FIG. 1 depicts an architecture of a computing system applicable to telemetry data management and processing techniques, according to an example.

FIG. 2 depicts a chiplet configuration used in a processor architecture adapted for telemetry data collection and monitoring, according to an example.

FIG. 3 depicts a flowchart of operations performed by telemetry monitoring circuitry, implemented by a monitoring unit of a processing chiplet, according to an example.

FIG. 4 depicts an example configuration of a multi-chiplet telemetry agent of a management chiplet adapted for telemetry data collection and monitoring, according to an example.

FIG. 5 depicts a flowchart of operations performed by telemetry monitoring circuitry, implemented by a multi-chiplet telemetry agent of a management chiplet, according to an example.

FIG. 6 depicts an architectural overview of an integrated compute platform including telemetry monitoring circuitry in a processing chiplet and multi-chiplet telemetry agent in a management chiplet, according to an example.

FIG. 7 depicts a flowchart of an example method for telemetry monitoring, according to an example.

FIG. 8 depicts a hardware arrangement of a data center used to provide multiple implementations or instances of a computing system, according to an example.

FIGS. 9A and 9B depict arrangements of a chip assembly with expanded views of chiplets and processing units, according to an example.

FIG. 10 depicts a block diagram of a computing system, according to an example.

### DETAILED DESCRIPTION

The following introduces implementations of computer hardware units for telemetry operations, applicable in processor architectures such as chiplet-based processors, System-on-chip (SoC) circuitry, System-in-Package (SiP) or System-on-Package (SoP) circuitry, and other modular packaging implementations of processor circuitry. The following hardware implementation specifically provides distributed telemetry entities that can be distributed across various tiles of the processor architecture. These distributed telemetry entities can work together to perform monitoring of specific resources mapped to certain software applications or processes.

For example, monitoring of a compute process can include using one or more distributed telemetry entities, including a “telemetry monitoring circuitry”, which may be, for example, configured as a “monitoring unit” included in a processing chiplet. The distributed telemetry entities can use the monitoring unit to identify different aspects of resource usage of a process, based on resources mapped to a corresponding process identifier such as a Process Address ID (PASID). These distributed telemetry entities can perform sampling to automatically identify outlier conditions or abnormal behaviors in the resources being used by a process, or in resources that are identified as related (or relevant) to the process or an associated application or service. The distributed telemetry entities can also broadcast events and information to other peers of the processor architecture, to help identify abnormal situations and to provide notifications to a management software stack when needed.

To enhance this approach in a chiplet-based processor architecture, some of the following implementations also operate a specialized type of telemetry agent, referred to as a “multi-chiplet telemetry agent”, which may be provided as a dedicated monitoring chiplet located on the SoC/SiP, or provided as another hardware component in a larger platform or system (e.g., located off the SoC/SiP but connected to the chiplets). This telemetry agent offers functionality to identify events occurring in resources across multiple chiplets of the processor architecture, to identify and perform advanced actions of telemetry coordination, monitoring, and eventing.

The telemetry monitoring circuitry provided by either type of chiplet (e.g., the monitoring units located in processing chiplets, or the telemetry agent located in a dedicated monitoring chiplet) can apply various artificial intelligence and/or learning techniques to assist telemetry data collection and analysis. Such learning techniques may include opportunistic learning to correlate performance vulnerabilities or critical points of failure in hardware with the events identified in software that are triggered by such vulnerabilities or points of failure.

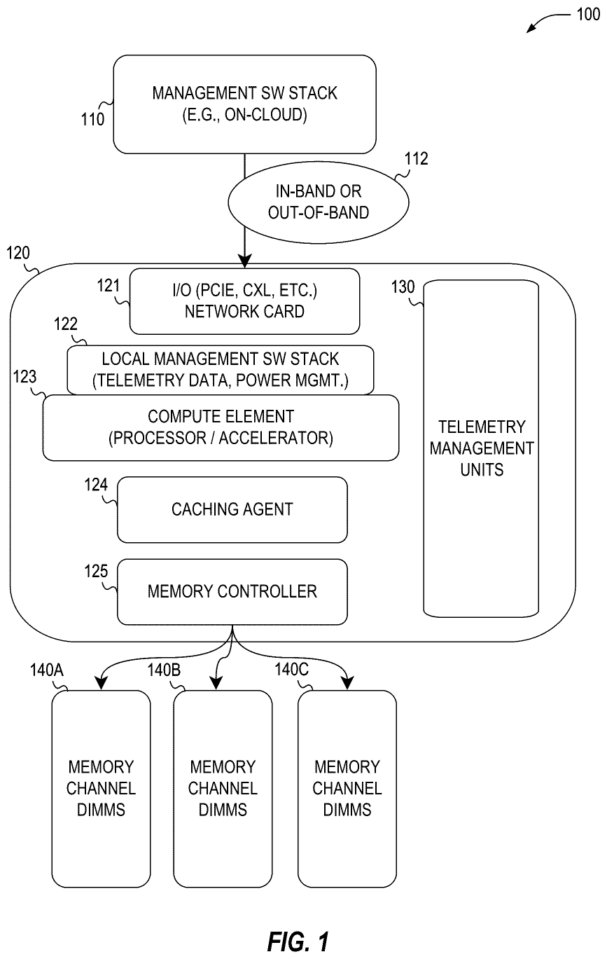

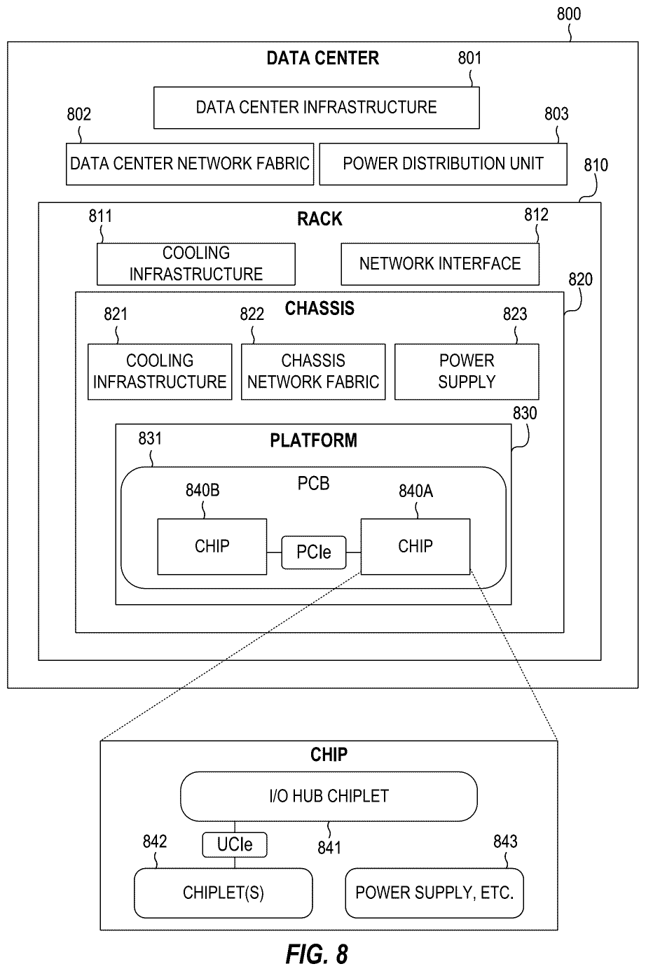

FIG. 1 depicts an example architecture of a computing system, applicable to the telemetry data processing techniques discussed herein. This architecture shows a compute platform 120 (e.g., provided from circuitry implemented as an SoC, SiP, SoP, or as a compartmentalized chipset with multiple chips and packages) that includes a network interface 121 to perform I/O operations (e.g., with network communication circuitry), a compute element 123 (e.g., a central processing unit (CPU), accelerator, etc.), and a local management software stack 122 (e.g., loaded software instructions and data) that executes on the compute element 123. Additional implementation examples of the compute platform 120 are provided with reference to FIGS. 8, 9A, 9B, and 10, discussed below. The compute platform 120 is also depicted as including a caching agent 124 (e.g., circuitry implemented with cache memory on the same chip as the compute element 123 or nearby the compute element 123) and a memory controller 125 (e.g., circuitry implemented on the same chip as the compute element 123 or nearby the compute element 123). The memory controller 125 is used to write and read data from memory units 140A, 140B, 140C, such as respective memory channel modules (e.g., dual in-line memory modules (DIMMS) such as SDRAM modules).

As an operational example, the local management software stack 122 may collect telemetry data in response to hardware events detected by various telemetry management units 130. The local management software stack 122 may also perform power management and other functions to control operations of the compute platform 120, including but not limited to remedial actions that respond to hardware events and telemetry data. The compute platform 120 may receive commands from another implementation of a management software stack 110, such as an on-cloud implementation of management software. The management software stack 110 may provide in-band or out-of-band communications 112 (e.g., received via the network interface 121) that retrieve telemetry data and provide commands to respond to detected telemetry data conditions. This telemetry data may be provided by other devices and systems included in, connected to, or under the control of the compute platform 120. Additionally, an I/O hub (not shown in FIG. 1) may be used to coordinate the collection, communication, and management of telemetry data.

Existing telemetry systems that only rely on logic from the management software stacks 110, 122 are often limited to data collection capabilities of the telemetry management units 130 based on fixed rules, such as to monitor specific elements of the platform and detect when a limited number of conditions occur. For instance, some prior approaches have used a monitor to register telemetry counters (often, four or fewer counters) and receive callbacks when overflows occur in these counters. Existing telemetry systems do not have built-in capabilities to correlate elements from multiple parts of the platform, and thus may not correctly identify or monitor wide-scale aspects of resource usage, especially among multiple cores and chips. Additionally, existing telemetry systems do not apply intelligence or learning in the hardware itself when analyzing telemetry events, as the compute platform will often need to rely on the management software stack 110 to perform more advanced actions.

Existing telemetry systems often cannot handle the challenges of processing a large amount of data generated in complex and unusual situations. As multi-tenancy continues to grow in prevalence with the explosive growth in the sizes of data centers and edge/cloud computing, the utilization of resources on individual computing platforms is often pushed to operational limits—often resulting in an unbalanced platform with different usages of resources. For instance, interconnects between platform elements can become the bottleneck if one application causes too much cross-socket traffic; but to accomplish an actionable remediation, the system needs the ability to correctly observe, monitor, and attribute system behavioral patterns to specific applications. At the same time, given the increasing complexity of compute platforms, there are many things to monitor—both at the application level and at the broader system level—which cannot be fully tracked with simple rules and existing telemetry monitors. The challenges of monitoring are compounded by the growth of real-time requirements and short-lived functions, which make it difficult for a system to know what problematic conditions to look for, when to look for the conditions, and where to look for the conditions. As a result, existing reactive telemetry approaches may not be suitable for a computing platform with many interconnected hardware elements.

Accordingly, there is a technical need to enable computing platforms to accurately trigger telemetry capture and evaluation, when needed, based on pre-defined rules and conditions in addition to dynamic changes and characteristics of events. This technical need is complicated by the significant technical challenges of how to monitor systems at scale, including deciding when to start and stop collecting telemetry data from individual hardware elements. Such technical issues increase in complexity for processor architectures that utilize chiplets and separate functions among different elements.

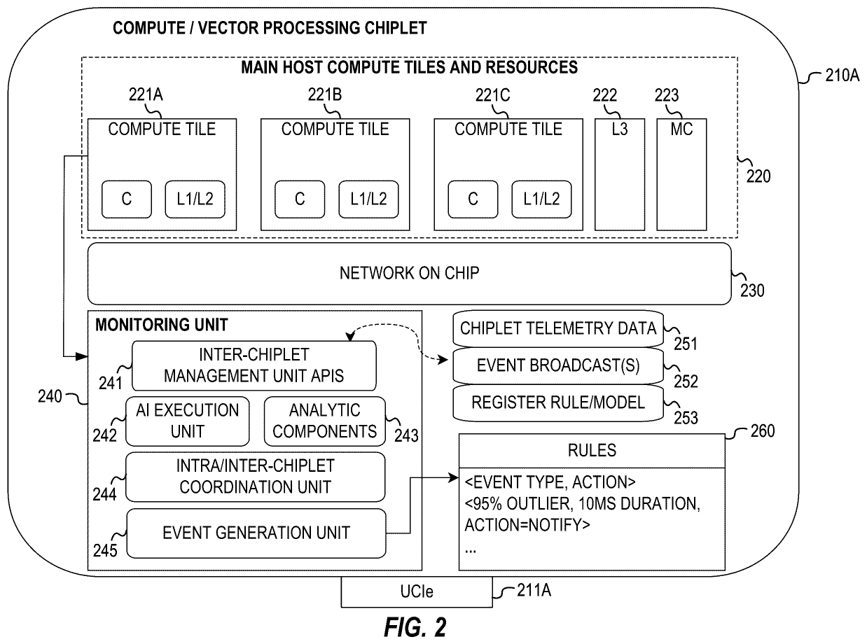

The approaches depicted in FIGS. 2 to 6 provide a hardware implementation that enables monitoring, analysis, and coordination of telemetry data events among multiple chiplets. These approaches include the use of out-of-band connections (and, where appropriate, end-to-end connections) from processing elements in a chiplet to respective telemetry monitoring and management entities (a monitoring unit) hosted within the chiplets. Such monitoring units provide a hardware implementation that can be distributed across many tiles of the architecture. Additionally, multiple of the monitoring units can be coordinated with a telemetry agent operating in a dedicated monitoring chiplet.

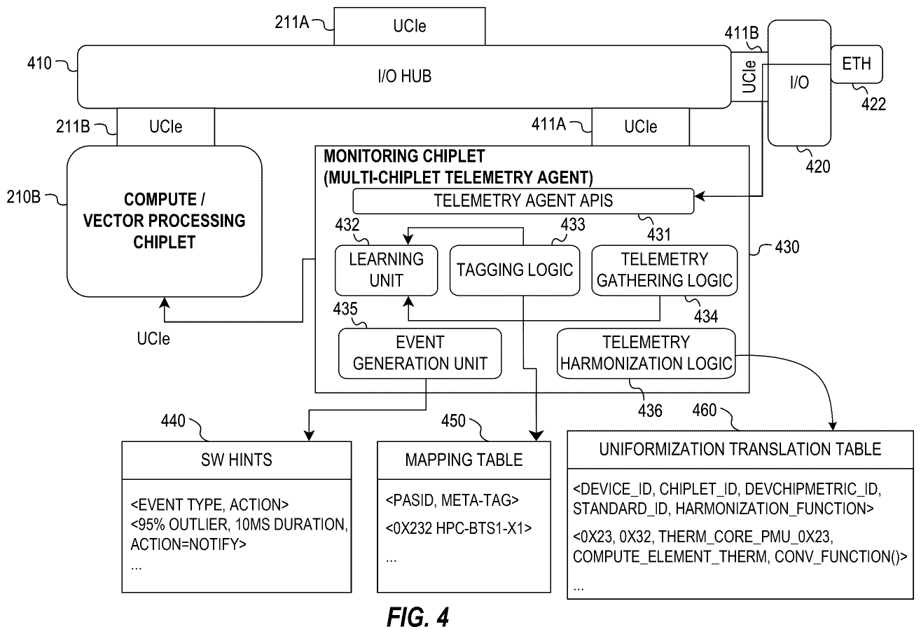

FIG. 2 depicts a chiplet configuration used in a processor architecture, showing a processing chiplet 210A (e.g., a compute processing chiplet or a vector processing chiplet) adapted for telemetry data collection and monitoring. This configuration shows the use of a telemetry monitoring circuitry which is configured as a monitoring unit 240 implemented in the chiplet, with the monitoring unit 240 being specialized circuitry that is responsible to identify critical resources and perform outlier analysis such as via advanced artificial intelligence (AI) models. The monitoring unit 240 may be a new component or logic block added to a chiplet—or an expansion of an existing monitoring unit of a chiplet—adapted to perform smart telemetry processing for the various applications executing on the chiplet. The information collected by the monitoring unit 240 may be communicated to other processing chiplets or to a dedicated telemetry monitoring chiplet, such as in events communicated to a multi-chiplet telemetry agent 430 implemented in a monitoring chiplet discussed with reference to FIG. 4 below.

In an example, the distributed monitoring units such as the monitoring unit 240 include functional components that observe and sense data from the operation of one or more compute units, such as the main host compute tiles and resources 220 shown in FIG. 2. In an example, the main host compute tiles and resources 220 include respective compute tiles 221A, 221B, 221C that respectively implement one or more compute cores (labeled as “C”) and cache such as L1 or L2 cache (labeled as “L1/L2”), other cache(s) accessible among multiple cores such as L3 cache 222, and other controller(s) such as memory controller 223, and the like. The resources 220 are connected to the monitoring unit 240 via a network-on-chip interface 230, such as in a scenario where the compute tile 221A provides telemetry data that can be captured and processed by the monitoring unit 240. In some examples, the network-on-chip interface 230 is provided by a fabric or interconnect that is used to communicate processing data and commands in addition to telemetry data. In other examples, a specialized or dedicated on-chip or on-package telemetry network may be used to quickly communicate telemetry data.

The monitoring unit also includes one or more application-programming interfaces (APIs) 241 that may receive and provide: telemetry data 251 from other chiplets of the computing platform; event data 252 such as events broadcast from other chiplets; and rule or model registration requests 253 from management software or other chiplets, including AI or ML model registration requests to register the use of specific models for analysis. Registration rules that map telemetry event types to specific remedial actions or notification actions (e.g., transmitting events), shown as rule set 260, can be provided by a software stack or can be identified and generated by the monitoring unit 240. The APIs 241 can also be used to receive hints in a broadcasted fashion by other processing chiplet peers to activate rules for more advanced monitoring for certain workloads, such as workloads identified with a specific PASID.

The monitoring unit 240 also includes an AI execution unit 242, analytic components 243, a chiplet coordination unit 244, and an event generation unit 245. In an example, for each application identified by a unique identifier (such as a process identifier e.g., PASID), the monitoring unit 240 will sample telemetry for the resources that are most utilized by the application, depending on the priority of the application. The monitoring unit 240 performs analysis on the sampled telemetry data via one or more data analytics models executing on the AI execution unit 242 and/or with use of the analytic components 243. For example, the one or more data analytics models may apply algorithms such as: principal component analysis (PCA) to identify which metrics are relevant; Long Short-Term Memory (LSTM) recurrent neural networks to identify what metrics are relevant over time; K-Nearest Neighbor or K-Means algorithms to identify clusters and to trigger a notification of outliers; and the like.

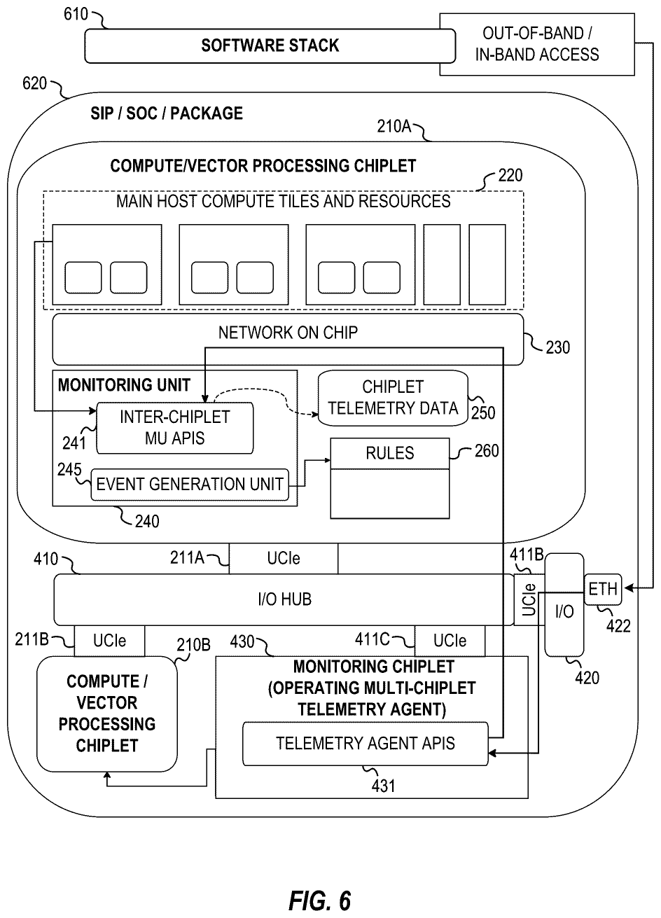

The AI execution unit 242 can trigger the event generation unit 245 to provide events that activate certain types of rules across the compute platform, such as rules that are registered by the management software stack (e.g., with a software stack 610, discussed with reference to FIG. 6) or indicated by a multi-chiplet unit (e.g., with the multi-chiplet telemetry agent 430, discussed with reference to FIG. 4). The chiplet coordination unit 244 can be used to coordinate telemetry monitoring, event detection, rules, broadcasts, within the chiplet itself (e.g., with intra-chiplet coordination), or with multiple other chiplets of the compute platform (e.g., with inter-chiplet coordination).

The monitoring unit 240 performs various data analysis to identify critical resources, and automatically or dynamically decide whether to collect telemetry data from the critical resources, perform outlier analysis on the telemetry data, and trigger events based on the analysis. Outliers can be identified from sophisticated outlier analysis (e.g., with a trained outlier identification model or outlier classification model) or simple monitoring rules. As used herein, an “outlier” refers to data points that have some significant, measurable, or observable deviation from other data points, and the observation of such an outlier is referred to herein as a “outlier condition”.

For instance, the events provided in the event generation unit 245 can generate one or more of the following actions. A first action may include to notify the software stack that some anomaly or condition has been identified and provide the related telemetry data. A second action may include to broadcast to other peer chiplets to trigger more advance monitoring. A third action may include to notify the multi-chiplet telemetry agent 430 that an event has been identified.

Periodically, as the monitoring unit 240 identifies the most relevant telemetry data, additional telemetry data aspects can be collected and provided to the multi-chiplet telemetry agent 430 (along with the process identifier, PASID) so the multi-chiplet telemetry agent 430 can learn how to identify and respond to the anomaly or condition, such as by collecting telemetry data and notifying other monitoring units when certain conditions occur. In this fashion, the monitoring unit 240 can gather telemetry data and assist with automatic outlier analysis for applications of the platform—even if the processing chiplet 210A is only executing part of the process associated with the application.

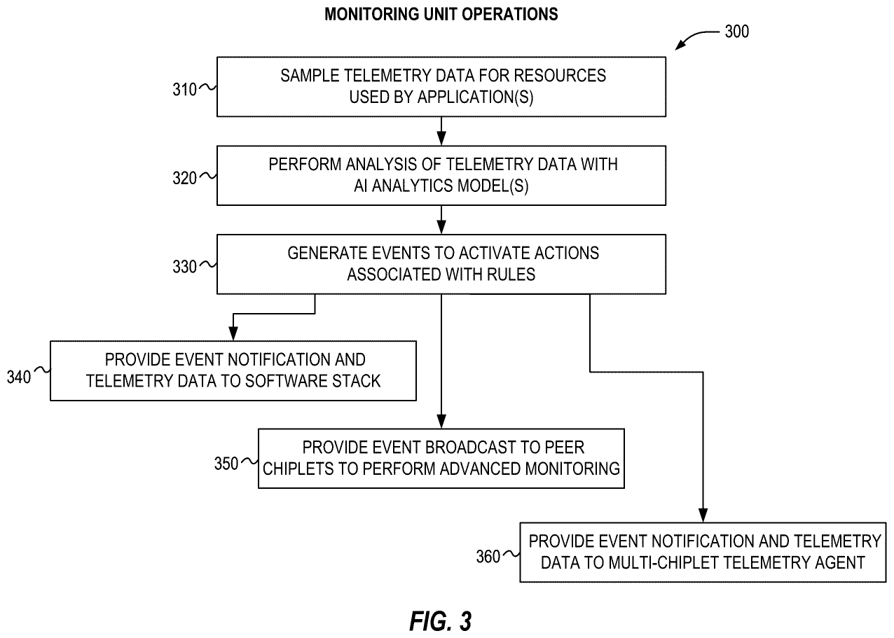

FIG. 3 depicts a flowchart 300 of a simplified overview of operations performed by the monitoring unit 240 of a respective chiplet, such as with the use of the components of the monitoring unit (e.g., AI execution unit 242, analytic components 243, chiplet coordination unit 244, event generation unit 245) or components in other chiplets. It will be understood that more complex analysis and event triggering may be provided in connection with these operations. Additionally, although this flowchart 300 depicts operations to perform the polling or sampling of telemetry data, corresponding operations can be triggered based on push notifications or events (e.g., telemetry data events that are identified and broadcast, or that are notified from the software stack).

At operation 310, the monitoring unit 240 samples telemetry data from hardware units used by the various applications executing locally on the chiplet, such as in the chiplet's compute tiles and hardware resources (e.g., the main host compute tiles and resources 220) to obtain telemetry data samples associated with execution of a process on the hardware units. For instance, telemetry data may be provided or sampled from processing cores, caches, communication or network interfaces, controllers, etc.

At operation 320, the monitoring unit 240 performs analysis of the telemetry data samples, using one or more analytics models, to identify an outlier condition applicable to the execution of the process. This may include the execution of trained AI models with the AI execution unit 242. This may also include analytic functions performed with the analytic components 243. Various anomalies or data triggers may be identified using the models and functions.

At operation 330, the monitoring unit 240 generates at least one event for additional telemetry data analysis associated with the process. The at least one event is to activate one or more actions associated with rules, such as with use of the event generation unit 245 that triggers one or more particular actions based on applicable event rules in rule set 260. For example, suppose that some performance metric associated with throughput of the compute cores is known to be within a particular range, such that there is an outlier condition defined if some measurable value is an outlier (e.g., a 95% outlier, outside the range of where 95% of the data is expected to occur) that occurs for some period of time (e.g., for a minimum of 10 milliseconds). If this condition occurs, then an event may be triggered based on a defined rule, to notify other chiplets to monitor and respond to the outlier condition (e.g., by capturing relevant telemetry data).

A first example of a generated event to activate one or more actions is provided by operation 340. This operation includes providing an event notification (and optionally, the associated telemetry data) to a management software stack, such as the software stack 610 discussed below.

A second example of a generated event to activate one or more actions is provided by operation 350. This operation includes providing an event broadcast to other instances, such as peer chiplets, to trigger the peer chiplets to perform advanced monitoring of some aspect related to the telemetry data on these other chiplets. For example, an event generated by a monitoring unit 240 of the processing chiplet 210A might be communicated to a corresponding monitoring unit of a processing chiplet 210B, depicted in FIGS. 4 and 6.

A third example of a generated event to activate one or more actions is provided by operation 360. This operation includes providing an event notification (and optionally, the telemetry data) to a multi-chiplet telemetry monitoring unit, such as the multi-chiplet telemetry agent 430 depicted in FIGS. 4 and 6. It will be understood that any combination of operations 340, 350, and 360 may be generated.

Thus, the monitoring unit 240 can generate broadcasts to software monitoring functions or other chiplets in the computing platform to activate more advanced monitoring or remedial actions among multiple chiplets. Various rules or logic may be established so that the software stack can be notified only if a collective outlier or condition is identified at multiple locations of the platform. The multi-chiplet telemetry agent 430 may also be used to coordinate the telemetry data collection and sensing of a collective outlier or condition of a process, including times to escalate, and specific remedial actions or types of actions to take within the platform.

The monitoring unit 240 uses the learning unit to apply learnings from telemetry collected over time to learn how to identify certain types of telemetry data, system conditions, and potential mitigations or remedial actions. To accomplish this learning, the system allows applications to be tagged with certain metadata that can uniquely identify the application (or type of application) that the monitoring unit can track to perform the learning.

FIG. 4 depicts an example configuration of a multi-chiplet telemetry agent 430, which in the depicted example is implemented as a separate chiplet and connected to multiple processing chiplets of the computing platform. For instance, the multi-chiplet telemetry agent 430 may be connected to processing chiplet 210B (connected via UCIe interface 211B), processing chiplet 210A (not shown, connected via UCIe interface 211A), and the like, via an I/O Hub 410. The I/O Hub 410 may utilize the UCIe protocol and a UCIe interface 411A to connect the multi-chiplet telemetry agent 430 to the other chiplets and a network interface, such as an Ethernet interface 422 provided via I/O 420 and UCIe interface 411B. Other interconnects, interfaces, and protocols may be used, including interfaces or communication buses (or dedicated lanes and bandwidth on these interfaces or buses) specialized for the communication of telemetry data. Thus, it will be understood that telemetry data and related telemetry events or commands can also be communicated via a non-UCIe interface.

The multi-chiplet telemetry agent 430 coordinates telemetry data events across the various processing chiplets of the compute platform, and includes decision logic to trigger, cause, or control additional telemetry actions. Actions can take different forms such as: manage or coordinate telemetry actions of the local agents on the various processing chiplets; notify a software stack (e.g., software stack 610); attempt to mitigate the identified problem and assign more or fewer resources to one specific tile or multiple tiles for the corresponding process (e.g., a process identifiable by a PASID); or implement custom actions in an attempt to mitigate or further monitor the condition. As the multi-chiplet telemetry agent 430 provides mitigation decisions, the corresponding effects are monitored and used to perform transfer learning to the model and refine the mitigation strategies.

The multi-chiplet telemetry agent 430 includes various interfaces and logic to establish a configuration in response to detected conditions. Such interfaces may include telemetry agent APIs 431 that receive and communicate information with management software (e.g., a software stack 610). For example, these interfaces can receive and register meta-data, and receive actions or software hints related to the event generation or triggering.

The multi-chiplet telemetry agent 430 includes a learning unit 432 to derive new models to perform the advanced telemetry data analysis actions. These may occur in connection with one of two approaches. A first approach is to identify when outliers and unusual situations occur for a particular type of application, e.g., identified by a unique identifier. A second approach is to learn mitigation actions to resolve certain actions. This can include learning using models such as reinforced learning. This learning can provide or refine models to provide basic actions, which can become more turned as the system operates and encounters new conditions.

The multi-chiplet telemetry agent 430 includes a tagging logic 433, such as implemented with a process identifier (e.g., PASID, process address space ID) to metadata-tagging function that allows mapping of telemetry coming from specific processes identified with a particular PASID to the application type itself. An application type could be generic such as “high-performance computing” (HPC) or specific per type and user, or variants thereof. The results of this mapping can be established in a mapping table 450, such as a table that associates a PASID with a meta-tag. A particular type may be associated with a set of particular characteristics (e.g., memory-bound characteristics, CPU-bound characteristics, etc.) that can assist the processing of relevant telemetry.

The multi-chiplet telemetry agent 430 includes an event generation unit 435 to coordinate the distribution of events among management units of the processing chiplets. The event generation unit 435 may use or define various software hints 440 that define different event types and actions for the events, and such event information can be implemented in the monitoring units as rules (e.g., rule set 260).

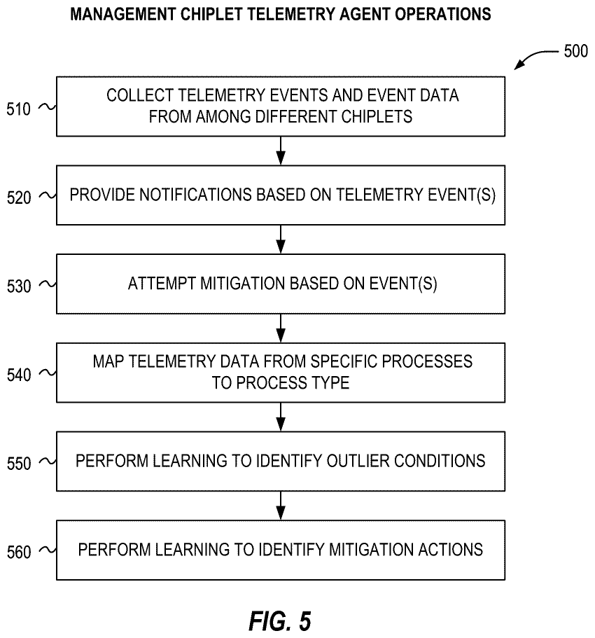

FIG. 5 depicts a flowchart 500 of a simplified overview of operations performed by the multi-chiplet telemetry agent 430 in a dedicated monitoring chiplet, such as with the use of multiple components implemented in the monitoring chiplet (e.g., learning unit 432, tagging logic 433, telemetry gathering logic 434, event generation unit 435) or related functions. It will be understood that additional analysis and event triggering may be provided in connection with these monitoring units and functions.

At operation 510, actions are performed by the multi-chiplet telemetry agent 430 to collect telemetry events and event data from among different chiplets of the package (e.g., chiplets such as processing chiplet 210A, processing chiplet 210B, etc. located throughout the SoC or SoP/SiP) or platform (e.g., from chiplets located among multiple packages or chip assemblies in a coordinated compute platform). Various APIs may be used to coordinate (e.g., subscribe, notify) these telemetry events and data among the respective chiplets, while the communications used to provide the events and data may be performed using a chiplet-to-chiplet or die-to-die data communication protocol (e.g., a protocol performed according to a Universal Chiplet Interconnect Express (UCIe) standard, or using specialized protocols for the communication of telemetry data and events).

At operation 520, the multi-chiplet telemetry agent 430 provides notifications (e.g., to monitoring units at the various processing chiplets) based on the telemetry event(s). This may cause some of the processing chiplets that have not sensed the condition or event to begin capturing telemetry data from the process or the process type. This may also cause other of the processing chiplets that have sensed the condition to capture additional types of telemetry data.

At operation 530, the multi-chiplet telemetry agent 430 may attempt to coordinate mitigation or mitigation actions in the compute platform based on the event(s). This may include applying mitigation with actions at the monitoring chiplet to re-allocate or optimize resources across the computing platform, based on prior learnings. For instance, multi-chiplet telemetry agent 430 may be aware of scenarios where some change was performed to a resource in the computing system to reduce the effects of an adverse outcome (e.g., to reduce utilization or latency of some resource).

At operation 540, the multi-chiplet telemetry agent 430 maps telemetry data collected from specific processes to a process type. This information can be used to help identify common anomalies or issues in the compute hardware that are occurring in the same type of application or service.

At operation 550, the multi-chiplet telemetry agent 430 performs learning (e.g., with the learning unit 432) to identify outlier conditions associated with the process type. At operation 560, the multi-chiplet telemetry agent 430 performs learning (e.g., with the learning unit 432) to identify new or updated mitigation actions associated with the process type. This learning may also include identifying the types of mitigation actions that are being initiated (e.g., by a user) in the hardware from the management software stack, so that these mitigation actions can be automatically recorded and launched in future executions of the process type.

The multi-chiplet telemetry agent 430 can be adapted for other types of predictive actions, to attempt to sense what will happen in the architecture, and then activate/deactivate some feature or aspect to obtain the telemetry data. This enables the collection of telemetry data and responses to the telemetry events for a variety of complex scenarios and event coordination.

A variety of use cases can be enabled to respond to different types of telemetry data conditions and events. For example, consider a simple rule that triggers telemetry data collection events X, Y, and Z, when CPU utilization exceeds some threshold (e.g., 90%). The use of processing cores located among multiple chiplets can complicate a measurement of this utilization, so the use of events between chiplets can help coordinate accurate detection and responses. As another example, suppose that the multi-chiplet telemetry agent 430 senses a high error correction code (ECC) rate occurring with memory operations, in addition to sensing temperatures above a certain threshold or abnormal rate. The multi-chiplet telemetry agent 430 may identify some correlation between events A, B, C, and D. The multi-chiplet telemetry agent 430 can attempt to identify this correlation, capture relevant telemetry data, and use the telemetry data to train and tune the models.

Telemetry data may be encompassed by a variety of definitions and standards. For instance, each chiplet or device provider may have different metrics and telemetry data definitions for the same properties. Likewise, standards bodies may define particular metrics applicable to wider industry usage, such as metrics provided with the OpenTelemetry standard (provided by the Cloud Native Computing Foundation). For instance, standards bodies might define power metrics associated with compute elements, thermal metrics, and other properties in a generic way but using very specific semantics and units (e.g., watts, etc.).

Some implementations of the multi-chiplet telemetry agent 430 can provide a harmonization of telemetry data metrics using a harmonization function such as the telemetry harmonization logic 436. The telemetry harmonization logic 436 maps multiple metrics into a common telemetry definition, based on a mapping to a harmonization function. For instance, consider a scenario where power metrics are provided by four different chiplets using different definitions. A harmonization of the power metrics into a common format can be performed using the telemetry harmonization logic 436, allowing an accurate evaluation and comparison of relevant power values.

The telemetry harmonization logic 436 uses a uniformization translation table 460 to map multiple properties of telemetry data to a relevant harmonization function. For instance, a device identifier, a chiplet identifier, a metric identifier, and a standard identifier may be associated with a harmonization function to be applied to incoming telemetry data. This harmonization function may be a conversion function that converts (e.g., changes) data from one format or type into a second format or type, but other types of functions may be used.

The data harmonization may be invoked by the gathering logic to harmonize the metrics originating from other chiplets or devices before processing the relevant data. This enables a robust integration of telemetry data from a variety of chiplets and devices. Accordingly, the telemetry harmonization logic 436 can harmonize various metrics to some common definition (e.g., a standard) to provide consensus and cohesive analysis of telemetry data from multiple sources.

FIG. 6 provides a simplified architectural overview of an integrated compute platform 620 (e.g., embodied by a SiP, SoC, or Package), showing how the elements of FIG. 2 and FIG. 4 including a monitoring unit 240 and a multi-chiplet telemetry agent 430 can be integrated into a computing system. Here, this architectural overview shows how multiple processing chiplets such as processing chiplet 210A and processing chiplet 210B are connected to the multi-chiplet telemetry agent 430, as the telemetry agent APIs 431 collects telemetry data and events from the various monitoring units (e.g. from the APIs 241). The multi-chiplet telemetry agent 430 receives out-of-band and in-band communications from the software stack 610 related to system conditions, events, and optimizations. The multi-chiplet telemetry agent 430 can also provide events to the various monitoring units of the processing chiplets, to coordinate applied rules and mitigations, and to cause the collection of additional telemetry data.

Additional collections and communications of telemetry data may be coordinated based on a hierarchy of coordination among the monitoring unit 240, the multi-chiplet telemetry agent 430, and other peers at higher layers or levels. Thus, the techniques discussed herein can apply to coordinate telemetry data events and collection not only between chiplets, but among packages and platforms, groups of platforms and devices, and other organizational groups (as scaled to larger systems).

Although the preceding discussed the use of various learning approaches including trained AI models and rule analysis, other aspects and variations of intelligent hardware processing and functions may be used. Such hardware and functions include but are not limited to, the use of neuromorphic hardware and spiking neural networks to provide triggers for specific detected telemetry data conditions. Other adaptations of AI models and data processing may be used to evaluate telemetry data from among multiple units. Some implementations may use recurrent neural networks (RNNs), Long Short-Term Memory (LSTM) networks, and the like to perform learning. Different types of models may be used to analyze/detect the data condition, depending on the type of data and the conditions to be analyzed.

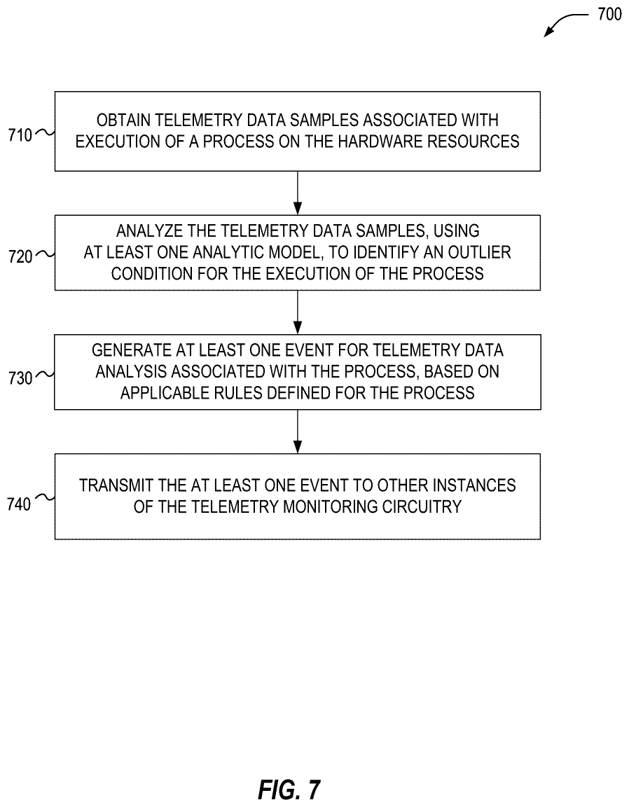

FIG. 7 depicts a flowchart 700 of an example method of monitoring telemetry data and providing telemetry data events in a compute platform, such as configured or performed in a compute platform implemented with processing circuitry hardware (e.g., integrated compute platform 620 embodied by a SiP, SoC, or Package) that includes compute circuitry (e.g., compute tiles and resources 220) and telemetry monitoring circuitry (e.g., monitoring unit 240 or multi-chiplet telemetry agent 430 implemented as a monitoring chiplet etc.). Other implementations of compute platforms and processing circuitry hardware are discussed below with reference to FIGS. 8, 9A, 9B, and 10.

Operation 710 includes obtaining telemetry data samples associated with execution of a process on the hardware resources (e.g., compute resources), such as hardware resources in a computing platform that are configured to perform compute operations. In one example, the telemetry data samples are obtained by telemetry monitoring circuitry that is configured as a monitoring unit in a chiplet (e.g., monitoring unit 240, operating as a local monitoring unit within a chiplet), and the hardware resources to perform the compute operations are co-located with the monitoring unit in the chiplet. In another example, the telemetry data samples are obtained by telemetry monitoring circuitry that is configured as a dedicated multi-chiplet telemetry monitoring unit (e.g., multi-chiplet telemetry agent 430).

Operation 720 includes analyzing the telemetry data samples, using at least one analytic model, and identifying an outlier condition for the execution of the process (e.g., an outlier condition that is triggered by or otherwise applicable to the process). In an example, the at least one analytic model includes an outlier identification model to identify the outlier condition, and a learning model to identify mitigation actions in response to the outlier condition.

Operation 730 includes generating at least one event for telemetry data analysis associated with the process, in response to identifying the outlier condition, based on applicable rules defined for the process. Thus, the identification of the outlier condition may cause the generation and communication of the at least one event, to then cause telemetry data analysis in other portions of the computing platform (e.g., to notify other instances of the telemetry monitoring circuitry in the computing platform with the event, to trigger these other instances to perform telemetry data analysis). Consistent with the examples above, the at least one event may include any combination of: an event to provide a notification to a management software stack; an event to provide a notification to other monitoring units in other chiplets; or an event to provide a notification to a multi-chiplet telemetry monitoring unit. The applicable rules may be identified based on a process type of the process, and the applicable rules may be associated with a remedial action or a notification action for the at least one event.

Operation 740 includes transmitting or otherwise providing the at least one event to other instances of the telemetry monitoring circuitry, For example, implementing operations may include transmitting the at least one event to the other instances of the telemetry monitoring circuitry in the computing platform, as the at least one event causes the other instances of the telemetry monitoring circuitry in the computing platform to obtain additional telemetry data associated with the execution of the process.

Additional operations (not depicted in FIG. 7) include receiving the applicable rules defined for the process, such as when receiving the applicable rules from a management software stack using an interface to the telemetry monitoring circuitry. Additional operations (not depicted in FIG. 7) also include identifying the applicable rules based on a process type of the process, such as when the applicable rules are associated with a remedial action or a notification action for the at least one event. The applicable rules may be activated and applied for use in analyzing the telemetry data samples associated with the execution of the process. The result of activating the applicable rules will lead to applying the applicable rules, such as when analyzing other telemetry data samples with the at least one analytic model (e.g., with operation 720), or analyzing additional telemetry data.

The operations 710 to 740 can be performed by a monitoring unit in a chiplet, such as when the hardware resources to perform the compute operations are co-located with the monitoring unit in the chiplet. In other examples, the operations are 710 to 740 are performed by a multi-chiplet telemetry monitoring unit, such as when the multi-chiplet telemetry monitoring unit establishes and manages mappings between an identifier of the process and metadata associated with the process. This mapping may be established among (e.g., between two of more of) an event type, event characteristics, and an action. This mapping can be used to identify the action to apply in the processing circuitry, in connection with applicable rules defined for the process. In further examples, a mapping may be established between a harmonization function and an identifier of one or more hardware resources. For instance, a harmonization function may be identified (e.g., based on an identifier of the hardware resources) and applied to translate telemetry data into a specific data format (e.g., a standardized telemetry format).

FIGS. 8, 9A, 9B, and 10 respectively depict simplified aspects of example computing architectures in which any of the techniques and configurations above may be implemented. It will be understood that the elements described above for telemetry monitoring and events may be integrated for use with various forms of the following hardware components, including for obtaining telemetry data from a variety of the following elements.

FIG. 8 depicts an example hardware arrangement of a data center 800 used to provide multiple implementations or instances of a computing system (e.g., computing system 1000, discussed below), with each instance of the computing system being identified as a respective platform (e.g., platform 830). The data center 800 includes data center infrastructure 801, a data center network fabric 802, and a power distribution unit 803 to support multiple racks of compute platforms, with a single instance of a rack 810 depicted. The data center infrastructure 801 may provide physical components that host the compute platform hardware, storage components, and networking equipment; the data center network fabric 802 may include switches and networking components to support data flows among various compute platforms and storage devices throughout the data center; and the power distribution unit 803 may include components to distribute and control power among the various compute platforms, networking, and storage devices.

The rack 810 includes but is not limited to cooling infrastructure 811, a network interface 812, and related physical components (not shown) to support discrete instances of multiple chassis. The rack 810 provides power, connectivity, and cooling to each of the multiple chassis in a single rack, with a single instance of a chassis 820 depicted in FIG. 8. The chassis 820 includes but is not limited to cooling infrastructure 821, a chassis network fabric 822, and a power supply 823, which provides cooling, network connectivity, and power to multiple platforms within the chassis, with a single instance of a platform 830 depicted in FIG. 8. It will be understood that a common data center rack configuration may include dozens of chassis, with each chassis adapted to support a number of platforms depending on the physical size of the platform hardware and supporting equipment.

The platform 830 in some implementations may be referred to as a server or node, depending on the use case for the platform 830 and the data center 800. The platform 830 includes but is not limited to implementations of a discrete computing system hosted on a single board. The platform 830 is depicted as hosting a chip assembly 840A and chip assembly 840B on a first board provided by a printed circuitry board (PCB) or other platform board, shown as PCB 831. In some examples, the platform 830 may include only one chip package, whereas the PCB 831 depicts interconnection of multiple chip assemblies via a device-to-device interface (e.g., a PCI express (PCIe) or compute express link (CXL) interface). Additional chip packages and components (not shown) may also be hosted on the PCB 831.

Some implementations of the chip assembly 840A and 840B may be termed as a System-on-Chip (SoC) package, as modular chiplets that perform different functions are integrated into a single package—even though this chip package is composed of multiple dies unlike a traditional SoC design that uses a single die. Other implementations of the chip assembly 840A and 840B may be termed as a System-on-Package (SoP), System-in-a-Package (SiP), or similar references to a single chip package. Various combinations of 2D, 2.5D, and 3D packaging technologies may be used to manufacture and assemble the chip package and its underlying structure, and different manufacturing processes may be used to provide chiplets and components from different process nodes (e.g., semiconductor fabrication systems).

The chip assembly 840A and chip assembly 840B are each packages that include multiple chiplets or dies for respective functions, such as separate chiplets for processing (e.g., CPU or GPU chiplets), memory (e.g., cache or high-bandwidth memory chiplets), I/O (e.g., I/O chiplets), acceleration (e.g., AI/ML acceleration chiplets), signal processing (e.g., audio or video processing chiplets), and the like. A close-up of chip assembly 840A is depicted as including a I/O Hub chiplet 841, chiplets 842, and a power supply 843. These components may be hosted on an interposer that is designed to connect multiple dies or components within a single semiconductor package (e.g., chip package). In some examples, the chiplets 842 may be manufactured and sourced separately and later assembled into the chip package to create the chip assembly 840A. Various connections may be provided among the chiplets 842 such as with the use of Universal Chiplet Interconnect Express (UCIe) or similar chiplet-to-chiplet interfaces and interconnects (e.g. Advanced Interface Bus (AIB), Bunch of Wires (BoW), etc.), or between chiplets and on-chip memory (e.g., high-bandwidth memory (HBM)) using HBM3 (JEDEC), Universal Memory Interface (UMI), or other memory interfaces. Similar interfaces and interconnects may be used for chip-to-chip or die-to-die communications (e.g., using NVIDIA® NVLink-C2C, Cache Coherent Interconnect for Accelerators (CIX), Compute Express Link (CXL), Advanced extensible Interface (AXI), and certain implementations of PCIe, CXL, etc.).

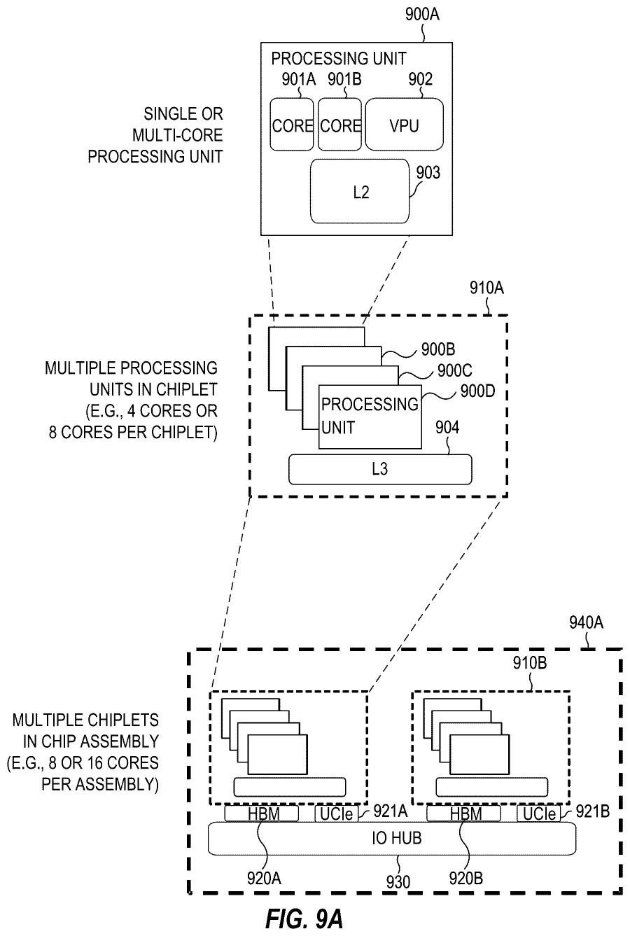

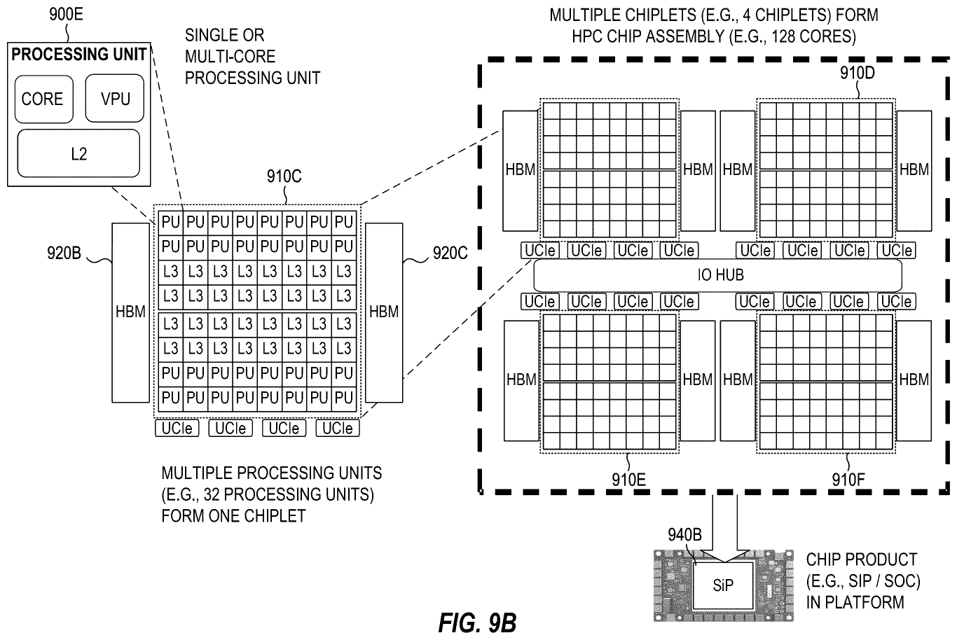

FIG. 9A depicts an example arrangement of a chip assembly 940A (e.g., a multi-processing core implementation of chip assembly 840A or 840B), with expanded views of the chiplets and processing units included therein. This arrangement shows how the chip assembly 940A, which may constitute a SoC, SoP, SiP, or other type of chip package, is composed from chiplets such as chiplet 910A, chiplet 910B, etc. and associated on-package memory (e.g., high-speed memory) such as 3D-stacked, HBM instances shown as HBM 920A, HBM 920B, interfaces (e.g., UCIe interfaces) shown as UCIe 921A, UCIe 921B, and I/O hub 930 (e.g., which may be implemented by a I/O chiplet). Other hardware elements of a chip package are not depicted for simplicity.

Each chiplet includes multiple processing units and each processing unit includes one or multiple cores. For instance, chiplet 910A as depicted includes four processing units (processing unit 900A, processing unit 900B, processing unit 900C, and processing unit 900D) and an L3 cache 904. Each processing unit may include one or multiple processing cores, one or multiple caches, and optionally other processing units or elements. For instance, processing unit 900A is depicted as including two cores (core 901A and core 901B), vector processing unit 902, and an L2 cache 903. Accordingly, a single-core processing unit arrangement can provide 4 cores per chiplet and 8 total cores in a two-chiplet chip assembly, whereas a dual-core processing unit arrangement can provide 8 cores per chiplet and 16 total cores in a two-chiplet chip assembly. Other permutations may also be provided. A variety of signaling interfaces and protocols (not shown) may be used for core-to-core and inter-processor communications, including but not limited to the use of coherency protocols, mesh, ring, or hybrid ring-mesh interconnects, Network-on-Chip (NoC) and packet switched communications, and the like.

FIG. 9B depicts an example arrangement of a chip assembly 940B (e.g., a multi-chiplet high-performance computing (HPC) implementation of chip assembly 840A, 840B), adapted for HPC applications (e.g., parallel processing operations involving thousands, millions, or more of processors or cores operating simultaneously). The example chip assembly 940B depicts placement as a SiP, SoC, or other package onto a platform board (e.g., PCB 831), and optionally in a data center (e.g., data center 800) or in a standalone deployment setting (e.g., in a standalone computer system, mobile computing device, autonomous device, etc.).

The chip assembly 940B is composed of multiple chiplets, shown with four chiplets, chiplet 910C, chiplet 910D, chiplet 910E, chiplet 910F. Each chiplet includes multiple processing units, such as 32 processing units with a corresponding L3 cache for each processing unit. Each processing unit may include one or multiple cores, such as a single-core processing unit 900E shown as part of chiplet 910C. The chip assembly 940B is also composed of corresponding memory resources, such as HBM elements corresponding to respective banks of processing units (e.g., HBM 920B and HBM 920C corresponding respective sets of processing units of chiplet 910C), UCIe interfaces, and an IO Hub.

The chip assembly and related products or devices described herein may be configured in a variety of computing system implementations. Such implementations include machine-readable non-transitory media storing machine-readable instructions and one or more processors coupled to the memory, such that executing the machine-readable instructions configure the computing system and implementing hardware (e.g., the processing unit 900, chiplet 910, chip 840, platform 830) to perform steps and operations described above for electronic systems or devices (e.g., to perform telemetry data collection, processing, eventing, etc. using the monitoring unit 240 or the multi-chiplet telemetry agent 430, etc.). It should be further understood that software including one or more computer-executable instructions that facilitate processing and operations as described above may be distributed, installed, or otherwise provided with networked devices (e.g., servers or cloud computing systems). Alternatively, in some examples, the software may be obtained and loaded (or, re-loaded/upgraded) from one or more servers and/or cloud computing systems, such as software stored on a server for distribution over the Internet, for example.

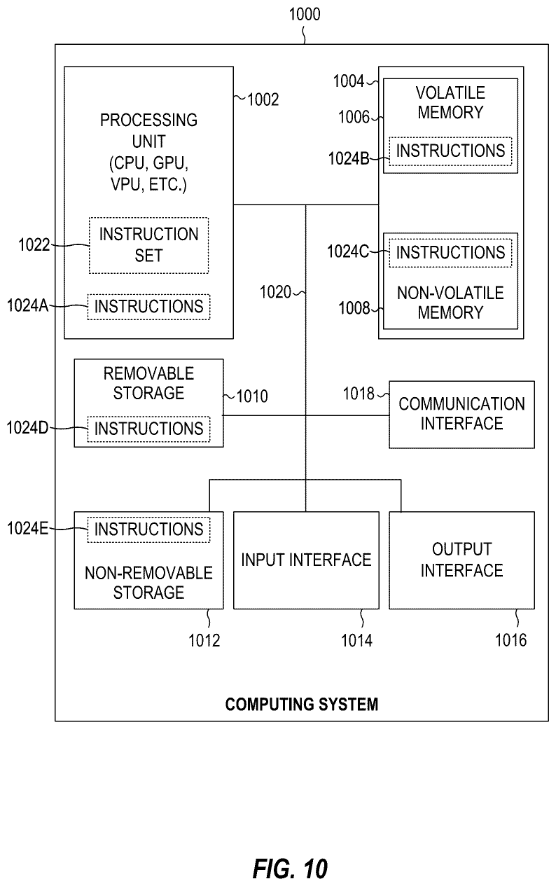

FIG. 10 depicts a block diagram of an example computing system 1000 (e.g., device, apparatus, machine, etc.) that may be programmed into a special purpose machine suitable for implementing one or more embodiments for telemetry data capture, analysis, monitoring, processing, communication, eventing, learning, or like aspects disclosed herein. For instance, the compute circuitry, monitoring unit circuitry, monitoring chiplet circuitry, or other compute sub-components described above may be embodied by the computing system 1000, such as in the form of a computer or specialized electronic device that includes sufficient processing power, memory resources, and communications throughput capability to perform operations consistent with the examples herein.

The computing system 1000 may include at least one hardware processing unit 1002 such as a central processing unit (CPU), a graphics processing unit (GPU), a vector processing unit (VPU), a neural processing unit (NPU), a hardware accelerator, or combinations or variants thereof. The at least one hardware processing unit 1002 is an implementation of processor circuitry and may be embodied by various types of chip assemblies, products, or packages as discussed with reference to FIGS. 8 to 9B. Circuitry (e.g., processing circuitry) as used herein is a collection of circuits implemented in tangible entities of the computing system 1000 that include hardware (e.g., simple circuits, gates, logic, etc.). Circuitry membership may be flexible over time. Circuitries include members that may, alone or in combination, perform specified operations when operating. In some examples, hardware of the circuitry may be immutably designed to carry out a specific operation (e.g., hardwired).

In an example, the hardware of the circuitry may include variably connected physical components (e.g., execution units, transistors, simple circuits, etc.) including a machine-readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the machine-readable medium elements can be part of the circuitry or communicatively coupled to the other components of the circuitry when the device is operating. Also, in some examples, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

The computing system 1000 may also include at least one memory device 1004 such as volatile memory 1006 and non-volatile memory 1008, and at least one storage device such as removable storage 1010 and/or non-removable storage 1012 such as a drive unit, some or all of which may communicate with each other via an interconnect, fabric, link, or bus 1020.

The computing system 1000 may include an output interface 1016 such as an interface connected to a display device, and an input interface 1014 such as an interface connected to an alphanumeric input device or a user interface (UI) navigation device. In some examples, a connected I/O device may also include a display device, alphanumeric input device, and navigation device that is integrated into a single unit such as a touch screen display.

The computing system 1000 may additionally include a communication interface 1018, such as for connection with a network interface device used to transmit and receive electronic signals on a network. The computing system 1000 may also include other interfaces or hardware (not shown) in connection with a signal generation device (e.g., an audio or radio signal generation device), an output controller (e.g., for connection with a serial, universal serial bus (USB), parallel, or other wired or wireless connection such as which uses via infrared (IR) or near field communication (NFC) technologies), an input controller (e.g., for connection with sensors or peripheral devices), and the like.

Any of the memory or storage devices such as the volatile memory 1006, the non-volatile memory 1008, the removable storage 1010, or the non-removable storage 1012 may provide a machine-readable medium. Some examples of a machine-readable medium are a non-transitory medium that hosts or stores one or more sets of data structures or instructions (e.g., software instructions) embodying or utilized by any one or more of the techniques or functions described herein. Such instructions are collectively labeled as instructions 1024 with respective implementations of instructions 1024A, 1024B, 1024C, 1024D, and 1024E.

The instructions 1024 may reside, during execution or other operation of the computing system 1000, completely or at least partially within the volatile memory 1006 as instructions 1024B, within non-volatile memory 1008 as instructions 1024C, within removable storage as instructions 1024D, within non-removable storage as instructions 1024E, or within the hardware processing unit 1002 as instructions 1024A. Thus, any combination of the hardware processing unit 1002, the volatile memory 1006, the non-volatile memory 1008, or a storage device of the removable storage 1010 or non-removable storage 1012 may constitute a machine-readable medium or media. The instructions 1024A, when loaded and executed by the hardware processing unit 1002, may invoke or utilize a defined instruction set 1022 of the hardware processing unit 1002, such as a processor instruction set defined by an instruction set architecture (ISA) of a reduced instruction set computer (RISC) or complex instruction set computer (CISC) architecture—including but not limited to the RISC-V Instruction Set provided in a RISC-V architecture. It will be understood that a RISC-V architecture and instruction set is one of several available architectures and instruction sets that may be used in implementations of the functional compute components (e.g., the hardware processing unit 1002) discussed herein.

The term “machine readable medium” may include any medium that is capable of storing, encoding, or carrying instructions for execution by components or the whole of the computing system 1000 (or a similar machine) and that cause the computing system 1000 or its components to perform any one or more of the techniques or functions described herein, or that is capable of storing, encoding or carrying data structures used by or associated with such instructions. Non-limiting machine-readable medium examples may include solid-state memories, and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; and optical or magneto-optical disks.

The instructions 1024 may further be transmitted or received over a communications network using a transmission medium via the communication interface 1018 and related devices utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), and wireless data networks (e.g., Institute of Electrical and Electronics Engineers (IEEE) 802.11 family of standards known as Wi-Fi®), IEEE 802.15.4 family of standards, peer-to-peer (P2P) networks, among others.

Method examples or other operations described herein can be implemented in part or in whole by the aforementioned machines, platforms, or devices, or related systems (including computer, robotic, and autonomous systems). The components of the illustrative devices, systems, and methods employed may be implemented in various examples by digital electronic circuitry, analog electronic circuitry, or in computer hardware, firmware, software, or in combinations of them. These components may be implemented, for example, as a computing program product such as a computing program, program code or computer instructions tangibly embodied in an information carrier, or in a machine-readable storage device, for execution by, or to control the operation of, a data processing apparatus such as a programmable processor, a computer, or multiple computers.

A computing program may be written in any form of programming language, including compiled or interpreted languages, and it may be deployed in any form, including as a stand-alone program or as a module, component, subroutine, or other unit suitable for use in a computing environment. Also, functional programs, codes, and code segments for accomplishing the techniques described herein may be easily construed as within the scope of the present disclosure by programmers skilled in the art.

Method steps associated with the illustrative embodiments may be performed by processing circuitry executing a computing program, code, or instructions to perform operations or functions (e.g., by operating on input data and/or generating an output). Further, such operations or functions may be embodied by a machine-readable medium, which is capable of storing instructions for execution by processing circuitry (including the specific processing unit examples discussed herein), such that the instructions, when executed by the processing circuitry, cause the processing circuitry to perform any one or more of the methodologies described herein.

Computer-readable instructions can be provided as processor instructions, interpreter instructions, or other types of directives, prompts, scripts, macros, templates, code injection annotations, or other data that are directly executed (e.g., on hardware, in an interpreter, virtual machine, etc.) compiled, assembled, combined, interpreted, obfuscated, compressed, encrypted, transpiled, or modified before the execution by processing circuitry. The computer-readable instructions may be decrypted, uncompressed, unpacked, or adapted prior to execution. Thus, computer-readable instructions encompass information that is provided in executable form (e.g., object code or binary executable code), information that is used to create an executable form of code, or information that is used to derive or create intermediate information used in connection with creation, distribution, or the execution of code. Computer-readable instructions may be provided not just from a single medium or computer system, but from multiple sources including remote networked sources.

Additional examples of the presently described embodiments include the following, non-limiting implementations. Each of the following non-limiting examples may stand on its own or may be combined in any permutation or combination with any one or more of the other examples provided below or throughout the present disclosure.

Example 1 is processing circuitry, comprising: compute circuitry, the compute circuitry comprising hardware resources configured to perform compute operations in a computing platform; and telemetry monitoring circuitry configured to: obtain telemetry data samples associated with execution of a process on the hardware resources; analyze the telemetry data samples using at least one analytic model, to identify an outlier condition applicable to the execution of the process; and in response to identification of the outlier condition, generate at least one event for additional telemetry data analysis associated with the process, based on applicable rules defined for the process, wherein the at least one event is provided to other instances of the telemetry monitoring circuitry in the computing platform.

In Example 2, the subject matter of Example 1 optionally includes subject matter where the telemetry monitoring circuitry is configured to: receive the applicable rules defined for the process, wherein the applicable rules are received from a management software stack using an interface to the telemetry monitoring circuitry.

In Example 3, the subject matter of any one or more of Examples 1-2 optionally include subject matter where the telemetry monitoring circuitry is configured to: identify the applicable rules based on a process type of the process, wherein the applicable rules are associated with a remedial action or a notification action for the at least one event; and activate the applicable rules for use in analyzing the telemetry data samples associated with the execution of the process.

In Example 4, the subject matter of any one or more of Examples 1-3 optionally include subject matter where the at least one analytic model includes: (i) an outlier identification model to identify the outlier condition, and (ii) a learning model to identify mitigation actions in response to the outlier condition; and wherein the outlier condition is based on a deviation in the telemetry data samples.

In Example 5, the subject matter of any one or more of Examples 1-4 optionally include subject matter where the telemetry monitoring circuitry is configured to: transmit the at least one event to the other instances of the telemetry monitoring circuitry in the computing platform; wherein the at least one event causes the other instances of the telemetry monitoring circuitry in the computing platform to obtain additional telemetry data associated with the execution of the process.

In Example 6, the subject matter of any one or more of Examples 1-5 optionally include subject matter where the telemetry monitoring circuitry is configured as a monitoring unit in a chiplet, and wherein the hardware resources to perform the compute operations are co-located with the monitoring unit in the chiplet.

In Example 7, the subject matter of any one or more of Examples 1-6 optionally include subject matter where the telemetry monitoring circuitry is configured as a dedicated multi-chiplet telemetry monitoring unit, and wherein the multi-chiplet telemetry monitoring unit is configured to: establish a mapping between an identifier of the process and metadata associated with the process.

In Example 8, the subject matter of Example 7 optionally includes subject matter where the multi-chiplet telemetry monitoring unit is further configured to: establish the mapping between among an event type, event characteristics, and an action; and use the mapping to identify the action to apply in the processing circuitry, in connection with applicable rules defined for the process.

In Example 9, the subject matter of any one or more of Examples 7-8 optionally include subject matter where the multi-chiplet telemetry monitoring unit is further configured to: identify a harmonization function to translate telemetry data into a data format, the harmonization function associated with an identifier of the hardware resources; and use the harmonization function to translate additional telemetry data associated with the execution of the process.

In Example 10, the subject matter of any one or more of Examples 1-9 optionally include subject matter where the at least one event for the additional telemetry data analysis includes: an event to provide a notification to a management software stack; an event to provide a notification to other monitoring units in other chiplets of the processing circuitry; or an event to provide a notification to a multi-chiplet telemetry monitoring unit of the processing circuitry.

In Example 11, the subject matter of any one or more of Examples 1-10 optionally include subject matter where the hardware resources to perform the compute operations comprise a plurality of compute tiles, and wherein each compute tile comprises at least one processor core and at least one cache associated with the at least one processor core.

In Example 12, the subject matter of any one or more of Examples 1-11 optionally include subject matter where the compute circuitry and the telemetry monitoring circuitry are implemented in a processing chiplet, and wherein the processing chiplet is configured to connect to at least one other chiplet via an interconnect.

In Example 13, the subject matter of any one or more of Examples 1-12 optionally include subject matter where the at least one event is provided transmitted to the other instances of the telemetry monitoring circuitry using a data communication protocol.

In Example 14, the subject matter of Example 13 optionally includes subject matter where the data communication protocol is performed according to a Universal Chiplet Interconnect Express (UCIe) standard.

Example 15 is a machine-readable medium including instructions, which when executed by processing circuitry, configures the processing circuitry according to any of Examples 1 to 14.

Example 16 is a method for telemetry monitoring, comprising operations to configure the processing circuitry according to any of Examples 1 to 14.

Example 17 is a method performed by telemetry monitoring circuitry, comprising: obtaining telemetry data samples associated with execution of a process on hardware resources, the hardware resources configured to perform compute operations in a computing platform; identifying an outlier condition applicable to the execution of the process, based on analysis of the telemetry data samples using at least one analytic model; and in response to identifying the outlier condition, generating at least one event for additional telemetry data analysis associated with the process based on applicable rules defined for the process, wherein the at least one event is provided to other instances of the telemetry monitoring circuitry in the computing platform.

In Example 18, the subject matter of Example 17 optionally includes receiving the applicable rules defined for the process, wherein the applicable rules are received from a management software stack using an interface to the telemetry monitoring circuitry.

In Example 19, the subject matter of any one or more of Examples 17-18 optionally include identifying the applicable rules based on a process type of the process, wherein the applicable rules are associated with a remedial action or a notification action for the at least one event; and applying the applicable rules to analyze the telemetry data samples associated with the execution of the process.

In Example 20, the subject matter of any one or more of Examples 17-19 optionally include subject matter where the at least one analytic model includes an outlier identification model to identify the outlier condition, and a learning model to identify mitigation actions in response to the outlier condition, wherein the outlier condition is based on a deviation in the telemetry data samples.

In Example 21, the subject matter of any one or more of Examples 17-20 optionally include transmitting the at least one event to the other instances of the telemetry monitoring circuitry in the computing platform; wherein the at least one event causes the other instances of the telemetry monitoring circuitry in the computing platform to obtain additional telemetry data associated with the execution of the process.

In Example 22, the subject matter of any one or more of Examples 17-21 optionally include subject matter where the method is performed by a monitoring unit in a chiplet, and wherein the hardware resources to perform the compute operations are co-located with the monitoring unit in the chiplet.

In Example 23, the subject matter of any one or more of Examples 17-22 optionally include subject matter where the method is performed by a multi-chiplet telemetry monitoring unit, and wherein the method comprises establishing a mapping, in the multi-chiplet telemetry monitoring unit, between an identifier of the process and metadata associated with the process.

In Example 24, the subject matter of Example 23 optionally includes establishing the mapping between an event type, event characteristics, and an action; and using the mapping to identify the action to apply in the computing platform, in connection with applicable rules defined for the process.

In Example 25, the subject matter of any one or more of Examples 17-24 optionally include identifying a harmonization function to translate telemetry data into a data format, the harmonization function associated with an identifier of the hardware resources; and applying the harmonization function to translate additional telemetry data associated with the execution of the process.

In Example 26, the subject matter of any one or more of Examples 17-25 optionally include subject matter where the at least one event for the additional telemetry data analysis includes: an event to provide a notification to a management software stack; an event to provide a notification to other monitoring units in other chiplets; or an event to provide a notification to a multi-chiplet telemetry monitoring unit.

In Example 27, the subject matter of any one or more of Examples 17-26 optionally include subject matter where the hardware resources to perform the compute operations comprise a plurality of compute tiles, and wherein each compute tile comprises at least one processor core and at least one cache associated with the at least one processor core.

In Example 28, the subject matter of any one or more of Examples 17-27 optionally include subject matter where the hardware resources and the telemetry monitoring circuitry are implemented in a processing chiplet, and wherein the processing chiplet is configured to connect to at least one other chiplet via an interconnect.

In Example 29, the subject matter of any one or more of Examples 17-28 optionally include subject matter where the at least one event is transmitted to the other instances of the telemetry monitoring circuitry using a data communication protocol.

In Example 30, the subject matter of Example 29 optionally includes subject matter where the data communication protocol is performed according to a Universal Chiplet Interconnect Express (UCIe) standard.

Example 31 is at least one non-transitory machine-readable medium comprising instructions stored thereon, which when executed by telemetry monitoring circuitry, causes the telemetry monitoring circuitry to: obtain telemetry data samples associated with execution of a process on hardware resources, the hardware resources configured to perform compute operations in a computing platform; identify an outlier condition applicable to the execution of the process, based on analysis of the telemetry data samples using at least one analytic model; and in response to identification of the outlier condition, generate at least one event for additional telemetry data analysis associated with the process based on applicable rules defined for the process, wherein the at least one event is provided to other instances of the telemetry monitoring circuitry in the computing platform.

In Example 32, the subject matter of Example 31 optionally includes subject matter where the instructions cause the telemetry monitoring circuitry to: receive the applicable rules defined for the process, wherein the applicable rules are received from a management software stack using an interface to the telemetry monitoring circuitry.

In Example 33, the subject matter of any one or more of Examples 31-32 optionally include subject matter where the instructions cause the telemetry monitoring circuitry to: identify the applicable rules based on a process type of the process, wherein the applicable rules are associated with a remedial action or a notification action for the at least one event; and applying the applicable rules to analyze the telemetry data samples associated with the execution of the process.

In Example 34, the subject matter of any one or more of Examples 31-33 optionally include subject matter where the at least one analytic model includes an outlier identification model to identify the outlier condition, and a learning model to identify mitigation actions in response to the outlier condition, wherein the outlier condition is based on a deviation in the telemetry data samples.

In Example 35, the subject matter of any one or more of Examples 31-34 optionally include subject matter where the instructions cause the telemetry monitoring circuitry to: transmit the at least one event to the other instances of the telemetry monitoring circuitry in the computing platform; wherein the at least one event causes the other instances of the telemetry monitoring circuitry in the computing platform to obtain additional telemetry data associated with the execution of the process.

In Example 36, the subject matter of any one or more of Examples 31-35 optionally include subject matter where the telemetry monitoring circuitry is implemented as a monitoring unit in a chiplet, and wherein the hardware resources to perform the compute operations are co-located with the monitoring unit in the chiplet.

In Example 37, the subject matter of any one or more of Examples 31-36 optionally include subject matter where the telemetry monitoring circuitry is implemented as a multi-chiplet telemetry monitoring unit, and wherein the instructions further cause the telemetry monitoring circuitry to establish a mapping between an identifier of the process and metadata associated with the process.

In Example 38, the subject matter of Example 37 optionally includes subject matter where the instructions cause the telemetry monitoring circuitry to: establish the mapping between an event type, event characteristics, and an action; and use the mapping to identify the action to apply in the computing platform, in connection with applicable rules defined for the process.

In Example 39, the subject matter of any one or more of Examples 31-38 optionally include subject matter where the instructions cause the telemetry monitoring circuitry to: Identify a harmonization function to translate telemetry data into a data format, the harmonization function associated with an identifier of the hardware resources; and apply the harmonization function to translate additional telemetry data associated with the execution of the process.

In Example 40, the subject matter of any one or more of Examples 31-39 optionally include subject matter where the at least one event for the additional telemetry data analysis includes: an event to provide a notification to a management software stack; an event to provide a notification to other monitoring units in other chiplets; or an event to provide a notification to a multi-chiplet telemetry monitoring unit.

In Example 41, the subject matter of any one or more of Examples 31-40 optionally include subject matter where the hardware resources to perform the compute operations comprise a plurality of compute tiles, and wherein each compute tile comprises at least one processor core and at least one cache associated with the at least one processor core.

In Example 42, the subject matter of any one or more of Examples 31-41 optionally include subject matter where the hardware resources and the telemetry monitoring circuitry are implemented in a processing chiplet, and wherein the processing chiplet is configured to connect to at least one other chiplet via an interconnect.

In Example 43, the subject matter of any one or more of Examples 31-42 optionally include subject matter where the at least one event is transmitted to the other instances of the telemetry monitoring circuitry using a data communication protocol.

In Example 44, the subject matter of Example 43 optionally includes subject matter where the data communication protocol is performed according to a Universal Chiplet Interconnect Express (UCIe) standard.

Example 45 is a system, comprising: an interface to receive telemetry data samples associated with execution of a process on hardware resources; and processing circuitry configured to: analyze the telemetry data samples using at least one analytic model, to identify an outlier condition applicable to the execution of the process; in response to identification of the outlier condition, generate at least one event for additional telemetry data analysis associated with the process based on applicable rules defined for the process; and communicate the at least one event to telemetry monitoring circuitry in the system.

Example 46 is an apparatus, comprising: compute means for performing compute operations; and telemetry monitoring means for: obtaining telemetry data samples associated with execution of a process on the hardware resources; analyzing the telemetry data samples using at least one analytic model, to identify an outlier condition applicable to the execution of the process; and in response to identification of the outlier condition, generating at least one event for additional telemetry data analysis associated with the process based on applicable rules defined for the process, wherein the at least one event is provided to other instances of the telemetry monitoring means.

Example 47 is an apparatus, comprising: interface means for receiving telemetry data samples associated with execution of a process; and processing means for: analyzing the telemetry data samples using at least one analytic model, to identify an outlier condition applicable to the execution of the process; in response to identifying the outlier condition, generating at least one event for additional telemetry data analysis associated with the process based on applicable rules defined for the process; and communicating the at least one event within the apparatus.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein. In the event of inconsistent usages between this document and any documents so incorporated by reference, the usage in this document controls.

What is claimed is:

1. Processing circuitry, comprising:
compute circuitry, the compute circuitry comprising hardware resources to perform compute operations in a computing platform; and
telemetry monitoring circuitry to:
obtain telemetry data samples associated with execution of a process on the hardware resources;
analyze the telemetry data samples with at least one analytic model, to identify an outlier condition applicable to the execution of the process; and
in response to identification of the outlier condition, generate at least one event for additional telemetry data analysis associated with the process based on applicable rules defined for the process, wherein the at least one event is provided to other instances of the telemetry monitoring circuitry in the computing platform.

2. The processing circuitry of claim 1, wherein the telemetry monitoring circuitry is to:
receive the applicable rules defined for the process, wherein the applicable rules are received from a management software stack via an interface to the telemetry monitoring circuitry.

3. The processing circuitry of claim 1, wherein the at least one analytic model is used based on the applicable rules identified for the process, a type of data in the telemetry data samples, and conditions to be analyzed.

4. The processing circuitry of claim 1, wherein the telemetry monitoring circuitry is to:
identify the applicable rules based on a process type of the process, wherein the applicable rules are associated with a remedial action or a notification action for the at least one event; and
activate the applicable rules to analyze the telemetry data samples associated with the execution of the process.

5. The processing circuitry of claim 1, wherein the at least one analytic model includes: (i) an outlier identification model to identify the outlier condition, and (ii) a learning model to identify mitigation actions in response to the outlier condition; and
wherein the outlier condition is based on a deviation in the telemetry data samples.

6. The processing circuitry of claim 1, wherein the telemetry monitoring circuitry is to:
transmit the at least one event to the other instances of the telemetry monitoring circuitry in the computing platform;
wherein the at least one event causes the other instances of the telemetry monitoring circuitry in the computing platform to obtain additional telemetry data associated with the execution of the process.

7. The processing circuitry of claim 1, wherein the telemetry monitoring circuitry is a monitoring unit in a chiplet, and wherein the hardware resources to perform the compute operations are co-located with the monitoring unit in the chiplet.

8. The processing circuitry of claim 1, wherein the telemetry monitoring circuitry is a dedicated multi-chiplet telemetry monitoring unit, and wherein the multi-chiplet telemetry monitoring unit is to:
establish a mapping between an identifier of the process and metadata associated with the process.

9. The processing circuitry of claim 8, wherein the multi-chiplet telemetry monitoring unit is further to:
establish the mapping among an event type, event characteristics, and an action; and
use the mapping to identify the action to apply in the processing circuitry, in connection with applicable rules defined for the process.

10. The processing circuitry of claim 8, wherein the multi-chiplet telemetry monitoring unit is further to:
identify a harmonization function to translate telemetry data into a data format, the harmonization function associated with an identifier of the hardware resources; and
use the harmonization function to translate additional telemetry data associated with the execution of the process.

11. The processing circuitry of claim 1, wherein the at least one event for the additional telemetry data analysis includes:
an event to provide a notification to a management software stack;
an event to provide a notification to other monitoring units in other chiplets of the processing circuitry; or
an event to provide a notification to a multi-chiplet telemetry monitoring unit of the processing circuitry.

12. The processing circuitry of claim 1, wherein the hardware resources to perform the compute operations comprise a plurality of compute tiles, and wherein each compute tile comprises at least one processor core and at least one cache associated with the at least one processor core.

13. The processing circuitry of claim 1, wherein the compute circuitry and the telemetry monitoring circuitry are implemented in a processing chiplet, and wherein the processing chiplet is to connect to at least one other chiplet via an interconnect.

14. The processing circuitry of claim 1, wherein the at least one event is transmitted to the other instances of the telemetry monitoring circuitry in accordance with a data communication protocol.

15. The processing circuitry of claim 14, wherein the data communication protocol is performed according to a Universal Chiplet Interconnect Express (UCIe) standard.

16. An apparatus, comprising:
means for receiving telemetry data samples associated with execution of a process on hardware resources, the hardware resources to perform compute operations in a computing platform;
means for identifying an outlier condition applicable to the execution of the process, based on analysis of the telemetry data samples with at least one analytic model; and
means for generating at least one event, in response to identifying the outlier condition, to perform additional telemetry data analysis associated with the process based on applicable rules defined for the process, wherein the at least one event is provided to other telemetry monitoring instances in the computing platform.

17. The apparatus of claim 16, comprising:
means for receiving the applicable rules defined for the process, wherein the applicable rules are received from a management software stack.

18. The apparatus of claim 16, comprising:
means for identifying the applicable rules based on a process type of the process, wherein the applicable rules are associated with a remedial action or a notification action for the at least one event; and
means for applying the applicable rules to analyze the telemetry data samples associated with the execution of the process.

19. At least one non-transitory machine-readable medium comprising instructions stored thereon, which when executed by telemetry monitoring circuitry, causes the telemetry monitoring circuitry to:
obtain telemetry data samples associated with execution of a process on hardware resources, the hardware resources to perform compute operations in a computing platform;
identify an outlier condition applicable to the execution of the process, based on analysis of the telemetry data samples with at least one analytic model; and
in response to identification of the outlier condition, generate at least one event for additional telemetry data analysis associated with the process based on applicable rules defined for the process, wherein the at least one event is provided to other instances of the telemetry monitoring circuitry in the computing platform.

20. The at least one non-transitory machine-readable medium of claim 19, wherein the at least one analytic model includes an outlier identification model to identify the outlier condition, and a learning model to identify mitigation actions in response to the outlier condition, and
wherein the outlier condition is based on a deviation in the telemetry data samples.

21. The at least one non-transitory machine-readable medium of claim 19, wherein the instructions cause the telemetry monitoring circuitry to:
transmit the at least one event to the other instances of the telemetry monitoring circuitry in the computing platform;
wherein the at least one event causes the other instances of the telemetry monitoring circuitry in the computing platform to obtain additional telemetry data associated with the execution of the process.

22. The at least one non-transitory machine-readable medium of claim 19, wherein the instructions cause the telemetry monitoring circuitry to:
establish a mapping between an event type, event characteristics, and an action; and
use the mapping to identify the action to apply in the computing platform, in connection with applicable rules defined for the process.

23. The at least one non-transitory machine-readable medium of claim 19, wherein the instructions cause the telemetry monitoring circuitry to:
identify a harmonization function to translate telemetry data into a data format, the harmonization function associated with an identifier of the hardware resources; and
apply the harmonization function to translate additional telemetry data associated with the execution of the process.
